(19) United States
(12) Patent Application Publication
(10) Pub. No.: US 2004/0120635 A1
(43) Pub. Date: Jun. 24, 2004

(54) Method and device for wavelength locking and spectrum monitoring

(76) Inventors: Ching-Yang Juan, Taoyuan (TW); Sean Chang, Taoyuan (TW)

Correspondence Address: LAW OFFICES OF DAVID PAI, 1001 FOURTH AVENUE, SUITE 3200, SEATTLE, WA, 98154, US

(21) Appl. No.: 10/607,954

(22) Filed: Jun. 26, 2003

(30) Foreign Application Priority Data
Dec. 18, 2002 (TW) 91136605

(51) Int. Cl. G02B 6/26

(52) U.S. Cl. 385/15; 385/37

(57) ABSTRACT

The invention discloses a method and device for wavelength locking and spectrum monitoring. A grating is used to divide a portion of input optical signals into a plurality of light beams that further form distinct response curves after passing through an etalon. The distinct response curves are transduced into electrical signals by photo detectors to generate a feedback signal calculated by a servo system so as to lock the center wavelength and monitor the full width at half maximum (FWHM) of the input optical signals.

### BACKGROUND OF THE INVENTION

(a) Field of the Invention

The invention relates to a method and device for wavelength locking and spectrum monitoring in optical fiber communications and, more particularly, to a method and device for wavelength locking and spectrum monitoring that utilizes a diffraction grating to introduce distinct optical path differences.

(b) Description of the Related Art

In the field of optical fiber communication, tunable optical components are extensively applied. For example, a tunable filter, instead of dense wavelength division multiplexing (DWDM), can be precisely tuned to the wavelength conforming to the International Telecommunication Union grid (ITU grid). Another example is the tunable laser used to replace the fixed-wavelength laser to significantly increase the application flexibility of optical fiber communication systems.

However, it is necessary that the aforesaid tunable optical components conform to the same standard grid for optical fiber communication in order to ensure the wavelength compatibility. Therefore, for fulfilling the wavelength compatibility, a wavelength locking mechanism is needed to make the optical component capable of locking the center wavelength within a specific range.

Referring to FIG. 1, a prior wavelength locking device includes a condensing lens 102, a multi-grating element 104, photo detectors 106A and 106B, and a servo system 108. In accordance with the prior method for spectrum monitoring, input optical signal, collimated after passing through the condensing lens 102, enters the multi-grating element 104. The multi-grating element 104 includes two or more gratings shown illustratively in FIG. 1 as gratings 104A and 104B. The grating 104A is designed for maximum reflection at a first optical wavelength λ₁ and the other grating 104B is designed for maximum reflection at a second optical wavelength λ₂. The two wavelengths are arranged on either side of the reference wavelength λ₀ such that an optical signal at wavelength λ₁ is reflected by grating 104A through lens 102 to optical detector 106A, and an optical signal at wavelength λ₂ is reflected by grating 104B through lens 102 to optical detector 106B. The photo detectors generate corresponding electrical signals indicative of the magnitude of the light reflected from gratings 104A and 104B, respectively. The electrical signals are supplied to a servo system 108 to generate an error signal indicative of the wavelength of an input signal and the error signal is fed back to a light source, thereby locking the center wavelength of optical signals outputted from the light source.

Nevertheless, the multi-grating element 104 employed in the prior art is forced to have paired gratings for maximum reflection at two wavelengths arranged on either side of the reference wavelength, so the assembly is wavelength specific as specified by the grating parameters and different units are required for different wavelengths, thus lacking wavelength tunability. Also, the gratings are fabricated to match the specific wavelength, therefore the fabrication process thereof is both complicated and costly. In addition, the number of the gratings in the multi-grating element 104 is limited, thus lacking the flexibility for practical applications.

### BRIEF SUMMARY OF THE INVENTION

Therefore, an object of the invention is to provide a method and device for wavelength locking and spectrum monitoring capable of accurately locking input optical signals to conform to a wavelength reference such as the ITU grid.

According to the invention, a grating and an etalon are combined for forming distinct response curves. The distinct response curves are then transduced to generate a difference or ratio signal that function as a feedback signal for the servo system, thus achieving the object of locking the center wavelength and monitoring the FWHM of the input light beam to conform to the ITU grid.

Through the design provided by the invention, only a common grating with low production cost is needed for composing a simple mechanism capable of accurately locking the center wavelength and monitoring the FWHM of the input light beam to conform to the ITU grid.

### BRIEF DESCRIPTION OF THE DRAWINGS

FIG. 1 shows a schematic view of a conventional wavelength locking device.

FIGS. 2A and 2B are schematic views illustrating the method for wavelength locking according to an embodiment of the invention.

FIG. 3 is a diagram showing the response curves of light beam P and light beam Q that pass through an etalon and showing the ITU grid with a spectral pattern before rotating the etalon according to an embodiment of the invention.

FIG. 4 is a diagram showing the response curves of light beam P and light beam Q that pass through an etalon and showing the ITU grid with a spectral pattern after rotating the etalon according to an embodiment of the invention.

FIG. 5 is a diagram showing the transmittance curve of a signal E, signal F, and feedback signal FB according to an embodiment of the invention.

FIG. 6 shows a schematic view illustrating a method of determining the zero point of the feedback signal to lock the center wavelength.

FIG. 7 is a diagram depicting the relationship between the flag A and the zero points of the feedback signal FB.

FIG. 8 shows a schematic view of another configuration used in the method of determining the zero point of the feedback signal to lock the center wavelength.

FIG. 9 shows a schematic view illustrating a spectrum monitoring method according to another embodiment of the invention.

FIG. 10 is a diagram showing the response curves of light beams M, N and O after passing through an etalon according to another embodiment of the invention.

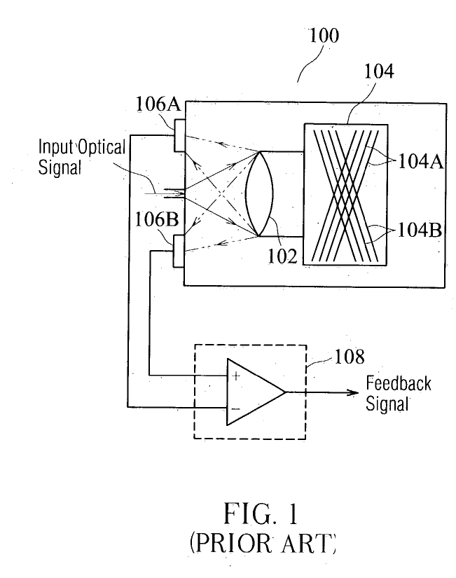

### DETAILED DESCRIPTION OF THE INVENTION

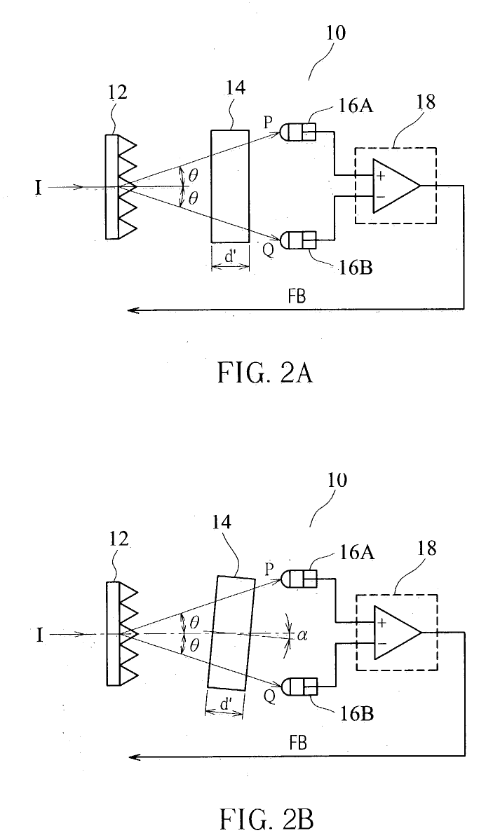

Referring to FIG. 2A, a wavelength locking device 10 according to the invention includes a grating 12, an etalon 14, photo detectors 16A and 16B, and a servo system 18.

A portion of light emitted from a light source (not shown) is induced as an input light beam I and enters the wavelength locking device 10. The input light beam I that impinges on the grating 12 is divided into two light beams P and Q at the same diffraction angle having the same level of optical power, and the light beams P and Q then enter the etalon 14.

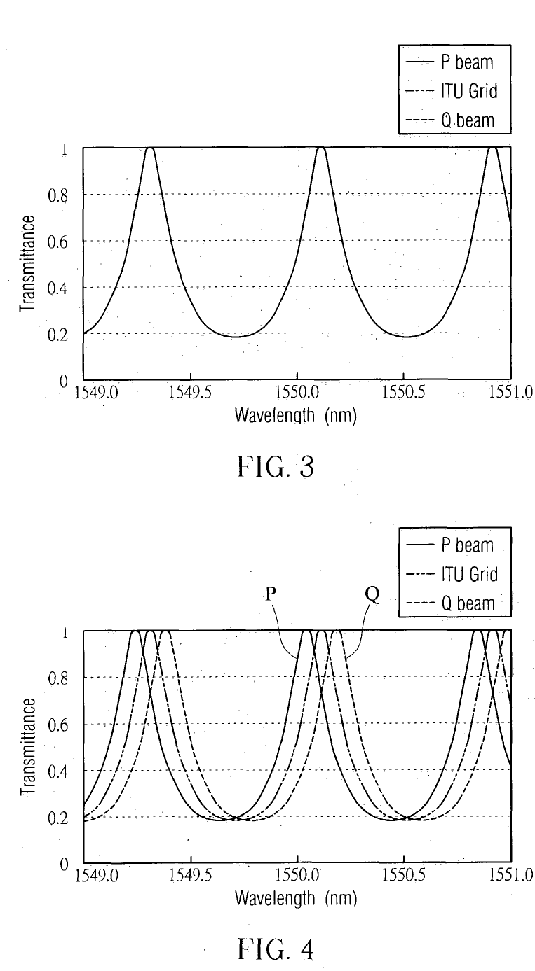

To start with the method of stabilizing the center wavelength of the optical signals I to conform to the International Telecommunication Union (ITU) grid, the response curves of light beams P and Q after passing through the etalon 14 must be adjusted to align with the ITU grid pattern, as shown in FIG. 3. Hence, the optical path difference d′ between the mirrors of the etalon 14 with respect to the light beams P and Q needs to be predetermined before proceeding with the wavelength locking steps. The value of d′ is calculated as below.

Suppose d is the selected optical path difference between the mirrors of the etalon 14, by which the response curve of the input light beam I after passing through the etalon 14 can align with the ITU grid pattern, and θ is the aforesaid diffraction angle, it is known that the free spectral range (FSR) with respect to the input light beam I is:

FSR1=λ²/2d (1)

and the FSR with respect to the light beams P and Q is:

FSR2=λ²/(2d′ cos θ) (2)

To make the response curves of the light beams P and Q align with the ITU grid pattern, it is necessary to have FSR1 equal FSR2. Hence, the predetermined optical path difference d′ of the etalon 14 with respect to the light beams P and Q is obtained:

d′=d/cos θ (3)

When the optical path difference d′ of the etalon 14 is predetermined to satisfy the equation (3), the response curves of the light beams P and Q after passing through the etalon 14 are identical and can both align with the ITU grid pattern, as shown in FIG. 3.

Next, referring to FIG. 2B, distinct optical path differences of the etalon 14 with respect to the light beams P and Q can be produced simply by rotating the etalon 14 at a small angle. By doing so, the response curves of the light beams P and Q after passing through the etalon 14 become distinct and deviate from the ITU grid pattern, as indicated in FIG. 4, where the peak of the response curve of the light beam P slightly drifts to the lower wavelength (to the left in the figure) while that of the light beam Q slightly drifts to the higher wavelength (to the right in the figure). Thus, the distinct response curves of the light beams P and Q can be regarded as the upper and lower reference values for locking the center wavelength of the input light beam I to conform to the ITU grid.

The photo detectors 16A and 16B can transduce the optical power of the distinct response curves of the light beams P and Q into electric signals E and F, respectively, and a feedback signal FB is formed by subtracting the electric signal F from the electric signal E. Thereby, the center wavelength of the light source is tuned by the servo system according to the feedback signal FB such that the difference as the feedback signal FB equals zero (E−F=0), meaning that the response curves of the light beams P and Q both align with the ITU grid pattern and the center wavelength of the input light beam I is locked within the range conforming to the ITU grid.

Therefore, with the combination of the grating 12 and the etalon 14 in connection with the invention, simply by rotating the etalon 14 at a small angle, the identical response curves of the split light beams passing through the etalon 14 that are intentionally designed to align with the ITU grid pattern in advance can become distinct ones that function as the upper and lower reference values for monitoring the spectrum. As a result, through the simple design, the center wavelength of the light source can be easily and accurately locked within the range conforming to the ITU grid.

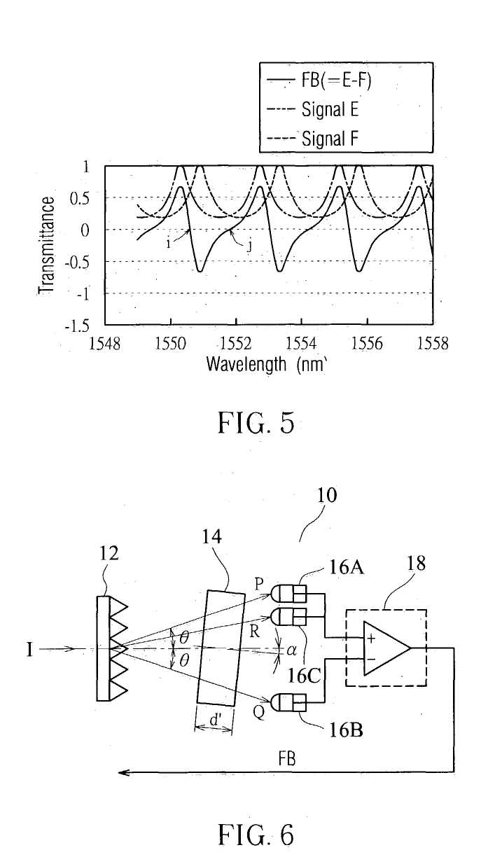

Referring to FIG. 5, the transmission curve of signals E, F and FB are shown. It is observed that when the transmittance of the signal FB, a difference of signals E and F, equals zero, the corresponding wavelength is not necessarily the center wavelength to be locked. For example, at both point i and point j the transmittance of signal FB equals zero, but only the wavelength corresponding to the point i is the center wavelength to be locked. For that reason, an alternative design is proposed as shown in FIG. 6. The Input light beam I is divided into three instead of two light beams, P, Q and R after passing through the grating 12, and the light beams P and Q are designed to have a stronger optical power than the light beam R. Also, the light beam R is transduced into an electric signal A by an additional photo detector 16C.

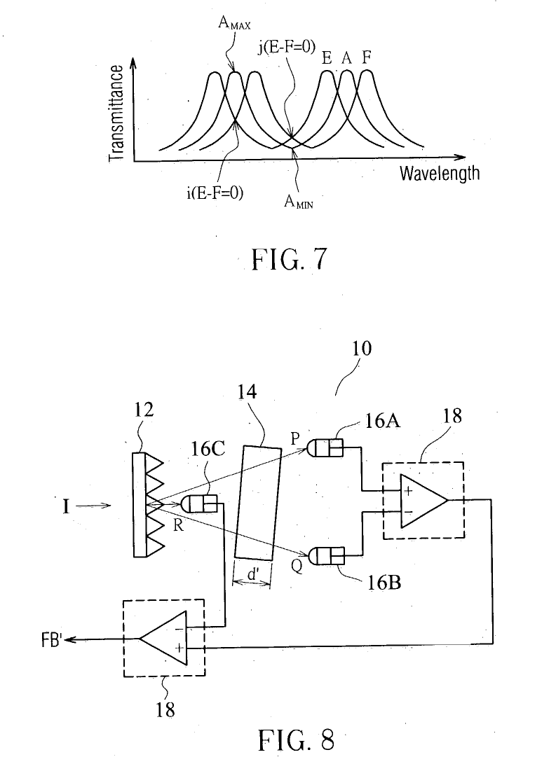

FIG. 7 clearly illustrates the relationship between the value of the electric signal A and the zero difference point i and j. As shown in FIG. 7, since the maximum A_{MAX} and minimum A_{MIN} of the electric signal A correspond, respectively, to point i and point j where the transmittance of signal FB equals zero, the zero point indicative of the wavelength to be locked is recognized as the point where the electric signal A is sensed as the maximum A_{MAX}. The signal A can be, therefore, adopted as a flag of the servo system 18 to determine which zero point of the feedback signal FB is indicative of the center wavelength to be locked.

FIG. 8 shows a schematic view of another configuration used in the method of determining the zero point of the feedback signal to lock the center wavelength. Referring to FIG. 8, input light beam I is split into three light beams P, Q and R after passing through the grating 12, with the optical power divided at a specific ratio through a designed diffraction angle. The light beams P and Q enter at an angle and penetrate through the etalon 14, and then photo detectors 16A and 16B receive and transduce the optical power into electric signals E and F, respectively. The servo system calculates the electric signals E and F to generate a feedback signal (the value of which equals E minus F) that is utilized to adjust the center wavelength of the light source to conform to the ITU Grid. The light beam R is transduced into an electric signal A by the photo detector 16C.

Since the measurement of the photo detector is sensitive to the wavelength of the optical signal, the feedback signal FB may, if the wavelength of the sensed optical signal varies, not steady, and thus the servo system is unable to control the feedback signal in a steady manner. Consequently, according to this embodiment, the photo detector 16C is disposed between the grating 12 and the etalon 14, and thus one portion of input light beam I is directly transduced into the electric signal A without passing through the etalon 14. Under the circumstances, the wavelength variation of the optical signal to be transduced is reduced, and the electric signal A may be regarded as a reference of the input optical power to normalize the feedback signal FB, such that a normalized feedback signal FB′ having a value of (E−F)/A is obtained. By doing so, the feedback signal FB′ may possess a more regular distribution and the servo system is able to accurately control the feedback signal for further locking the center wavelength of the light source.

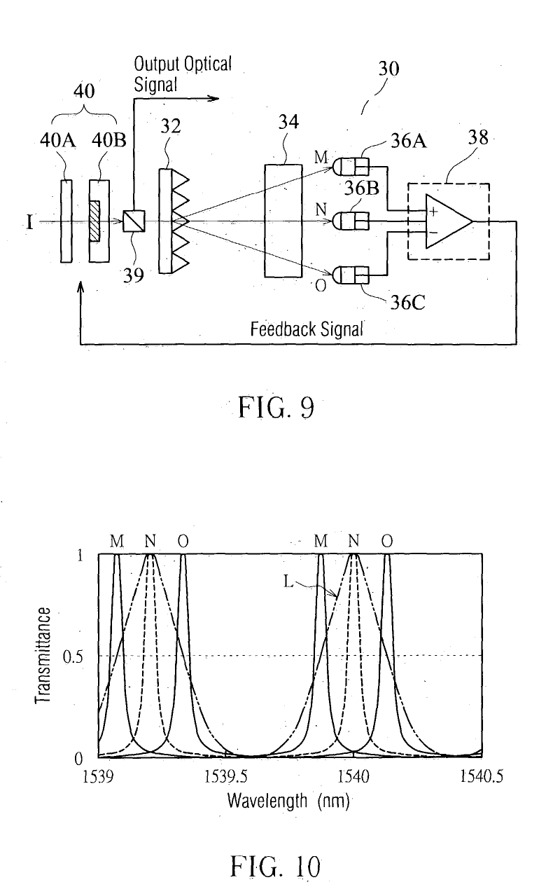

FIG. 9 shows a schematic view of a wavelength locking device for illustrating a spectrum monitoring method according to another embodiment of the invention. Referring to FIG. 9, the wavelength locking device 30 comprises a grating 32, an etalon 34, photo detectors 36A, 36B and 36C, a servo system 38 and a tunable Fabry-Perot device 40.

In the embodiment, after the input light beam I passes through the tunable Fabry-Perot device 40, a small portion of the input optical signal divided by a splitter 39, on the order of 5% of the optical power, enters the grating 32 while the remainder is transmitted as the output optical signal. The grating 32 divides the input light beam I into three light beams that have the same optical power and are incident at the etalon 34 at different angles. When the three light beams are incident at the etalon 34 at different angles, three distinct response curves M, N and O are formed as shown in FIG. 10 because of the optical path differences.

The parameters that affect the filtered spectrum of the tunable Fabry-Perot device 40 are defined as the following:

1. Free Spectral Range (FSR):

FSR=(λ²)/2nDₒₚ

wherein λ is the center wavelength, n is the optical index, Dₒₚ is the distance between two reflectors 40A and 40B;

2. Finesse (F):

1/F=1/F_{R}+1/F_{θ}(F_{R}=πR^{1/2}/1−R; F_{θ}=λ/2Dθ)

wherein R is the refractive index of the two reflectors 40A and 40B, D is the aperture of the etalon 34 for allowing optical signals to pass through, and θ is the tilt of the reflectors;

3. Full Width at Half Maximum (FWHM):

FWHM=FSR/F

In common optical fiber communication applications, the FWHM is a primary design parameter. To conform to the ITU 100 GHz grid, for instance, the response curve filtered through the aforesaid tunable Fabry-Perot device must satisfy the condition that the FWHM is 0.37 nm and the FSR is at least 40 nm to be within the spectral range of C band.

Referring to FIG. 10, three response curves M, N and O with the transmission peaks occurring in sequence are obtained from the three light beams passing through the etalon 34 at different angles. The three distinct response curves can be transduced into different electric signals by the photo detectors 36A, 36B and 36C. According to the embodiment, the electric signals W and Y are set as the transmittance transduced at half maximum (where the transmittance is 0.5 as shown in FIG. 10) of the response curves M and O, respectively, and the electric signal X is set as the transmittance transduced at the peak of the response curve N. Hence, when the ratio of the signal X and the signal W and the ratio of the signal X and the signal Y equal 2, it means that the response curve L of the input light beam I passing through the tunable Fabry-Perot device 40 has the FWHM, neither broadened nor narrowed, during the optical signal transmission. To the contrary, if the ratio of the signal X and the signal W or the ratio of the signal X and the signal Y does not equal 2, it means that the FWHM of the response curve L of the input light beam I has, due to temperature variation or other uncertainties, broadened or narrowed.

It is obtained from the equation, FWHM=FSR/F, that the FWHM can be tuned by adjusting the finesse F, and that the finesse F may be changed by varying the tilt θ of the reflector 40A or 40B. Therefore, when the servo system 38 compares the ratio of the signal X and the signal W with that of the signal X and the signal Y, the servo system 38 then, if the ratios do not turn out to be 2, feeds back an error signal for immediately adjusting the tilt θ of the reflector 40A or 40B, so as to accurately tune the response curve to have the desired FWHM conforming to the ITU grid.

In addition, the signals W and Y are not limited to being set as the transmittance transduced at half maximum of the response curves M and O, but any other appropriate range may be chosen. For example, when ⅓ of the peak level of the response curves M and O is set for the transduction of the signals W and Y, and the electric signal X is set as the value for transducing the optical power at the peak of the response curve N, then the ratio of the signal X and the signal W and the ratio of the signal X and the signal Y should equal 3 for the desired FWHM. That is, only a relationship having a particular ratio needs to be fulfilled, and the servo system adjusts the FWHM according to the ratio of the signals.

It is apprehended from the aforesaid embodiments in accordance with the invention that the invention utilizes a combination of a grating and an etalon, so that distinct response curves can be formed after the light beams pass through the etalon because of distinct optical path differences. The distinct response curves are then transduced to generate a difference or ratio signal that act as a feedback signal for the servo system, thus achieving the object of locking the center wavelength and monitoring the FWHM of the input light beam to conform to the ITU grid.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for wavelength locking in optical fiber communications comprising the steps of:
providing a portion of input optical signals as an input light beam;
dividing the input light beam into a plurality of sub light beams by a grating;
passing the sub light beams through an etalon for forming distinct response curves;
transducing the response curves into electric signals; and
comparing the electric signals for locking the center wavelength of the input optical signals.

2. The method for wavelength locking as described in claim 1, wherein the response curves are transduced to the electric signals by photo detectors.

3. The method for wavelength locking as described in claim 1 wherein the comparing step comprises:
making a calculation on the electric signals by a servo system to obtain a feedback signal; and
adjusting the center wavelength of the input optical signals according to the feedback signal.

4. The method for wavelength locking as described in claim 3, wherein the servo system utilizes one of the sub light beams as a flag for comparing the electric signals.

5. The method for wavelength locking as described in claim 4 further comprising a normalized step of normalizing the feedback signal by a reference signal transduced from one of the sub light beams.

6. The method for wavelength locking as described in claim 1, wherein the grating divides the input light beam into paired sub light beams at the same diffraction angle, and the etalon is rotated at an angle for forming distinct response curves.

7. The method for wavelength locking as described in claim 6, wherein before rotating the etalon, the response curves formed from the paired sub light beams passing through the etalon conform to the International Telecommunication Union (ITU) grid.

8. The method for wavelength locking as described in claim 7, wherein the distinct response curves of the paired sub light beams are transduced into two electric signals, and a servo system is adopted for generating a feedback signal by calculating the difference of the two signals.

9. The method for wavelength locking as described in claim 1 further comprising the spectrum monitoring steps of:
passing the input light beam through a tunable filter before being divided by the grating at different diffraction angles; and
adjusting the tilt of mirrors arranged in the tunable filter for changing the FWHM of the response curves of the input light beam.

10. The method for wavelength locking as described in claim 9, wherein the tunable filter is a Fabry-Perot filter.

11. The method for wavelength locking as described in claim 9 wherein a servo system is adopted for generating a feedback signal to adjust the tilt of the mirrors arranged in the tunable filter.

12. The method for wavelength locking as described in claim 9, wherein the transduction of the response curves comprises the steps of:
transducing the optical power at the peak of the response curve of a first sub light beam into a first electric signal;
transducing a proportion of the optical power at the peak of the response curve of the second sub light beam into a second electric signal; and
determining whether the ratio of the second electric signal to the first electric signal equals the proportion.

13. The method for wavelength locking as described in claim 12, wherein the proportion equals 0.5.

14. A method for locking wavelengths of a radiation source to the ITU grid comprising the steps of:
providing a portion of optical signals emitted from the radiation source as an input light beam;
dividing the input light beam into a plurality of sub light beams by a grating at the same diffraction angle;
passing the sub light beams through an etalon for forming response curves each conforming to the ITU grid;
rotating the etalon for forming distinct response curves deviated from the ITU grid pattern;
transducing the distinct response curves into electric signals; and
comparing the electric signals for locking the center wavelength of the radiation source conforming to the ITU grid.

15. A device for locking wavelengths of a radiation source comprising:
a grating to divide a portion of input optical signals emitted from the radiation source into a plurality of sub light beams;
an etalon to receive the plurality of sub light beams that further form distinct response curves;
a plurality of photo detectors for transducing the response curves into electric signals; and
a servo system for comparing the electric signals and generating a feedback signal to lock the center wavelength of the input optical signals.

16. The device for wavelength locking as described in claim 15 further comprising a wavelength tunable filter disposed between the radiation source and the grating.

17. The device for wavelength locking as described in claim 16, wherein the wavelength tunable filter is a Fabry-Perot filter.

18. The device for wavelength locking as described in claim 16, wherein the servo system generates a feedback signal after comparing the electric signals to adjust the finesse of the wavelength tunable filter for monitoring the FWHM of the input optical signals.
